(19) United States
(12) Patent Application Publication
(10) Pub. No.: US 2008/0277331 A1
(43) Pub. Date: Nov. 13, 2008

(54) Multisectional Filtering Device

(76) Inventor: Mikhail Yurievich Kudryavtsev, Lyublinskaya (RU)

Correspondence Address: PATENTTM.US, P. O. BOX 82788, PORTLAND, OR, 97282-0788, US

(21) Appl. No.: 12/159,389

(22) PCT Filed: Apr. 2, 2007
(86) PCT No.: PCT/RU2007/000159

§ 371 Date: Jun. 26, 2008

(30) Foreign Application Priority Data
Apr. 14, 2006 (RU) 2006112280

(51) Int. Cl. B01D 24/12; C02F 1/42; B01D 25/02

(52) U.S. Cl. 210/266

(57) ABSTRACT

This invention relates to systems for division of the materials mixed in the fluid medium being filtered, for example, for purification of water at power stations.

Multisectional filtering device for division of the materials mixed in the fluid medium being filtered contains sections being connected to each other with executed in each section bringing and removing hollows and a sorbent located in sections, moreover sections have the identical sizes and are executed everyone in the form of a prism with the six-angle basis and with walls being parallel and identical in pairs, the sections' bases form the device's two butts' walls being parallel to each other, sections adjoin to each other so that the lateral wall separating two neighbour sections is general for them, and all walls are rigidly connected among themselves.

As a result high compactness, reliability of joints of channels, adaptability to manufacture and simplicity of change of the scheme of sections' connection, smaller consumption of materials, and also applicability for half-continuous filtering are reached.

Hatches in sections' bases being parallel allow to rearrange identical cartridges with a sorbent inside sections for more effective utilization of a sorbent.

### FIELD OF THE INVENTION

This invention relates to systems for division of the materials mixed in the fluid medium being filtered, for example, for purification of water at power stations.

### PRIOR ART

The radial filter for purification of liquids is known, in cylindrical case of which are placed the central distributive chamber and coaxially on distance one from another the circular filtering chambers (sections) filled up by loose sorbent (see copyright certificate SU 1816474, B 01 D 24/08, May 23, 1993).

Because this filter is multisectional, its compactness is higher in comparison with the filtering devices, having in each case one section of filters carrying out such functions as selective filtering of the initial medium and as selective regenerating of sections.

However for repairing this filter the stop of filtering process is required. Therefore for guarantee of a continuity of filtering, it is necessary to reserve filters with corresponding decrease in compactness of filtering device because of occurrence of space between filters and of deducing from work for the period of repair of the filter of all filtering sections, located in the repaired filter.

Closest to the invention at technical essence and at received result is the multisectional filtering device for division of the materials mixed in the fluid medium being filtered, containing sections being connected one to another with executed in each section bringing and removing hollows and a sorbent located in sections (see copyright certificate SU No 1346193, D 01 D 25/06, 23 Oct. 1987).

The said filtering device is executed in the form of blocks, and contains sections with elements connecting one section to another, located in sections bringing and removing hollows and the filtering elements (sorbent), moreover each section has the case, filtering elements have the closed form (ring) and are installed in a case on distance from walls, bringing channels are connected with a hollow between a filtering element and the case's wall, the removing channels—with a hollow in a filtering element, and in each channel the valve is installed. The described design allows to delete alternatively (for example, for repair or regeneration) and to replace sections of the filter without stop of filtering in the other sections and to raise again the compactness of filtering device due to reduction of number of filtering elements simultaneously deduced of work for the period of regeneration or repair. However in this design the joining and undocking of channels by displacement does not allow to reach the tightness of joining of channels in working position of sections. Moreover a plenty of channels with the valves in one section reduces the adaptability to manufacture of the given filtering device, and the design of the section's case in the form of a parallelepiped with a joint along perimeter is rather material-intensive for guarantee of the preset strength, for example against internal pressure.

Common faults of filtering devices described above are:
The closed form of working volume of a sorbent (the sorbent concludes inside of itself entrance hollow or outlet hollow and itself is surrounded by outlet hollow or entrance hollow) demands great volume of ring hollows for alignment of speeds of medium on front of a filtration, and that reduces compactness of device;
Constructive complexity of change of the scheme of connection of sections, for example, at multistage filtering at devices of periodic action (the period of filtering-the period of regeneration) with switching off for regeneration of the first stage's section and with its switching on after regeneration as last stage;
Inapplicability for filtering by half-continuous way (with movement of a bulk sorbent by portions from filtering sections into sections of regeneration and back) having in many cases the best technical and economic parameters in comparison with filtering at devices of periodic action.

### SUMMARY OF THE INVENTION

Invention being described is directed on increase of compactness and of adaptability to manufacture of filtering device.

The technical result of realization of filtering device is to reduce its mass and its sizes and to increase its reliability of work.

The specified problem is solved and the technical result is reached because multisectional filtering device for division of the materials mixed in the fluid medium being filtered contains sections being connected to each other with executed in each section bringing and removing hollows and a sorbent located in sections, moreover sections have the identical sizes and are executed everyone in the form of a prism with the six-angle basis and with walls being parallel and identical in pairs, the sections' bases form the device's two butts' walls being parallel to each other, sections adjoin to each other so that the lateral wall separating two neighbour sections is general for them, and all walls are rigidly connected among themselves.

Executed in section bringing and removing hollows can be located outside of working volume of a sorbent.

Sections' walls can be executed as two facing sheets with the reinforcing elements and/or filler placed between sheets for fastening these sheets among themselves.

In the sections' bases forming one of device's butts' walls the hatches can be executed.

At least two neighbour sections can be connected among themselves by at least one channel executed through a lateral wall separating them.

Device can have supports, moreover at least one support can be executed as vessel.

Device can consist of three, six, ten or fifteen sections with bases' centers located by the rows filling a triangle with length of the side equal according one, two, three or four steps between centers of the bases.

Industrial filtering devices, as a rule, are the set of the filters connected by pipelines and located in industrial premises. The cost of device in ratio to its productivity is defined both by adaptability to manufacture, and by compactness of the device characterized in working volume of a sorbent in ratio to volume of space borrowed by device in premises.

High compactness of device being described is provided firstly due to minimizing space between filters and reduction of number of sections simultaneously deduced from work for the period of regeneration or repair.

Secondly, compactness is raised in comparison with the prototype because the hollows for bringing and removing the medium being filtered are located outside of working volume of a sorbent. Such location reduces the volume of these hollows with preserving of alignment of speeds of medium on front of filtering. For example, at vertical position of device's butts' walls the working volume of a sorbent in section can borrow all space between vertical lateral walls, and hollows being remained outside of a sorbent will have the minimal volume in the form of prisms with the triangular basis at the minimal hydraulic losses in the devices distributing the medium on front of filtering. In this case due to a multi-storey location of sections the area of the filtering front in ratio to the premises' area can be considerably increased too.

Thirdly, that the sections' bases form two parallel butts' walls of device, allows not only to reduce to a minimum the space between device and flat walls or floor of premises, but also in some cases to use the device as a wall or floor, i.e. allows not only to raise compactness of device, but also to lower the consumption of materials by object as a whole.

High adaptability to manufacture of device is reached due to the sections' sizes identity providing the uniformity of constructive elements.

A mutual immovability of sections of this filtering device provides the reliability of sections' joints and the simplicity of change of the scheme of sections' connections, allowing to reduce to a minimum the number of channels connecting the sections and to use standard pipeline joints and standard pipeline armature for channels in the sections' bases. It also raises adaptability to manufacture of device.

The section's form as a prism with the six-angle basis allows to reduce the width of lateral walls of section at the preset volume of section in comparison with the device closest to the invention and due to it allows to reduce the consumption of materials by walls between sections at preservation of preset strength, for example against internal pressure. For reduction of cost of manufacturing of device the walls can be executed as two facing sheets with the reinforcing elements and/or filler placed between sheets for fastening these sheets among themselves.

Because the hollows for bringing and removing the medium being filtered are located outside of working volume of a sorbent, it allows to organize counter movement of the medium being filtered and a sorbent and so to provide half-continuous filtering.

Thus high compactness, reliability of joints of channels, adaptability to manufacture and simplicity of change of the scheme of sections' connection, smaller consumption of materials, and also applicability for half-continuous filtering are distinctive features of this device.

Hatches for service of sections, for example, for replacement of a sorbent can be executed in the sections' bases forming one of device's butts' walls. The unilateral location of hatches decreases the zone of service of that butt wall where there are no hatches, i.e. decreases the space borrowed by device and raises compactness.

If there is no necessity to change the scheme of connection of some sections, then at least two neighbour sections can be connected among themselves by at least one channel executed through a lateral wall separating them. It will decrease the space borrowed by pipelines in premises.

Device can have supports, moreover at least one support can be executed as vessel. The use of these vessels for mediums for regenerating will reduce the need for separately located vessels connected with filtering device, i.e. will raise compactness of system of filtering as a whole. The form of these vessels can be chosen such to receive the best for space reducing in premises external outlines of device.

Device can consist of three, six, ten or fifteen sections with bases' centers located by the rows filling a triangle with length of the side equal according one, two, three or four steps between centers of the bases. It is possible to construct by such devices the complex filtering systems in premises having the complex form with observance of high compactness.

### BRIEF DESCRIPTION OF THE DRAWINGS

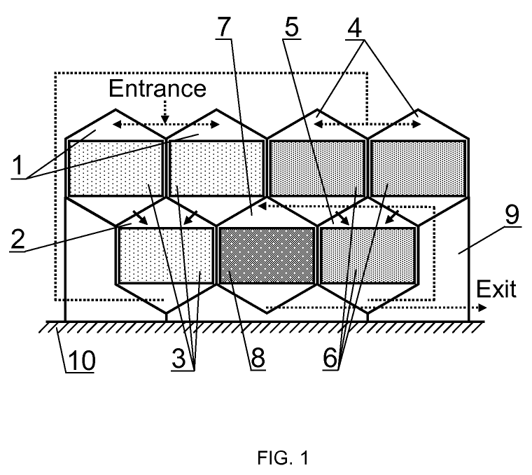

Described filtering device is schematically shown on FIG. 1.

On the drawing the vertical sectional view of multisectional filtering device acting periodically with filtering from top to down, intended for purification of water by ion-exchange is shown.

### DESCRIPTION OF PREFERRED EMBODIMENTS

The sections' bases and two lateral walls of each section are vertical. The plane of a cut is parallel to the bases. Dot lines with arrows show the pipelines connecting channels in the sections' bases and located between filters and show the movement in these pipelines of the medium being filtered. Single arrows show the movement of this medium through channels in lateral walls of sections.

There are incorporated in this device:
cation filter consisting of two sections (1) of first step and one section (2) of second step and containing in sections the cation exchanger (3);
anion filter consisting of two sections (4) of first step and one section (5) of second step and containing in sections the anionite (6);
mechanical filter consisting of section (7) containing mechanical sorbent (8).

Device have supports (9) executed as vessels for mediums for regenerating. These supports are established on a floor (10).

For an opportunity of switching-off sections for regeneration of a sorbent the pipelines on corresponding sites can be connected to pipelines of other same sections, incorporated in other same device.

Described device works as follows.

The medium being filtered, for example water, moves by pipelines in parallel into the top part of two sections (1) of cation filter's first step. After purification in cation exchanger (3) of first step the water passes from the bottom part of sections (1) by channels in lateral walls into the top part of section (2) of cation filter's second step. After purification in cation exchanger (3) of second step the water from the bottom part of section (2) moves by pipelines in parallel into the top part of two sections (4) of anion filter's first step. After purification in anionite (6) the water from the bottom part of sections (4) by channels in lateral walls passes into the top part of section (5) of anion filter's second step. After purification in anionite (6) of second step the water from the bottom part of section (5) moves by pipelines into the top part of section (7) of the mechanical filter. After purification in a mechanical sorbent (8) cleared water from the bottom part of section (7) moves to the consumer.

For regeneration of a sorbent in any section this section must be disconnected from pipelines of the medium being filtered. If continuous filtering is necessary, the medium being filtered can move instead of disconnected section into connected in parallel with it same section of other same device. After that the regenerating medium is being given in calculated quantity into section disconnected from the medium being filtered. When the regenerating medium going is stopped, regenerated section is being washed from the regenerating medium's remainder. This section after washing is being connected again to pipelines of the medium being filtered.

### INDUSTRIAL APPLICABILITY

Described invention can be used in mechanical engineering, power industry and other industries where it is necessary to spend division of the mixed mediums and to spend purification of liquid mediums.

What is claimed is:

1. The multisectional filtering device for division of the materials mixed in the fluid medium being filtered contains sections being connected to each other with executed in each section bringing and removing hollows and a sorbent located in sections, characterized in that sections have the identical sizes and are executed everyone in the form of a prism with the six-angle basis and with walls being parallel and identical in pairs, the sections' bases form the device's two butts' walls being parallel to each other, sections adjoin to each other so that the lateral wall separating two neighbour sections is general for them, and all walls are rigidly connected among themselves.

2. A device according to claim 1, characterized in that, executed in section bringing and removing hollows are located outside of working volume of a sorbent.

3. A device according to claim 1, characterized in that sections' walls are executed as two facing sheets with the reinforcing elements and/or filler placed between sheets for fastening these sheets among themselves.

4. A device according to claim 1, characterized in that the hatches are executed in the sections' bases forming one of device's butts' walls.

5. A device according to claim 1, characterized in that, at least two neighbour sections are connected among themselves by at least one channel executed through a lateral wall separating them.

6. A device according to claim 1, characterized in that the device has supports, moreover at least one support can be executed as vessel.

7. A device according to claim 1, characterized in that the device consists of three, six, ten or fifteen sections with bases' centers located by the rows filling a triangle with length of the side equal according one, two, three or four steps between centers of the bases.
